(19) United States
(12) Patent Application Publication
(10) Pub. No.: US 2012/0324269 A1
(43) Pub. Date: Dec. 20, 2012

(54) MICROCONTROLLER AND METHOD FOR CONTROLLING POWER INDICATOR

(75) Inventor: WEI-DONG CONG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/452,961

(22) Filed: Apr. 23, 2012

(30) Foreign Application Priority Data
Jun. 15, 2011 (CN) 201110160375.0

(51) Int. Cl. G06F 1/26; G06F 1/28

(52) U.S. Cl. 713/340

(57) ABSTRACT

A microcontroller (MCU) and method controls a power indicator. The MCU reads an input voltage of a power supply device, reads an output voltage of the power supply device, and reads a power of the supply device. The MCU determines if the read input voltage of the power supply device falls within a predetermined input voltage range, determines if the read output voltage of the power supply device falls within a predetermined output voltage range, and determines if the read power of the power supply device falls within a predetermined power range. The MCU controls the power indictor to indicate a light according to a determination result of the power supply device.

### BACKGROUND

1. Technical Field

The embodiments of the present disclosure relate to control technology of electronic devices, and particularly to a microcontroller and method for controlling a power indicator.

2. Description of Related Art

A power supply device is an essential component of a computer, the power supply device provides power to start the computer. It is very important for a user to know a status of the power supply device when the user uses the computer. However, at present, the status of the power supply device is manually detected. For example, the user can manually set parameters using a specific application to detect the status of the power supply device at 10:00 AM. The status of the power supply device is not detected in real-time when the user uses the computer. This is tedious and time consuming and thus, there is room for improvement in the art.

### BRIEF DESCRIPTION OF THE DRAWINGS

FIG. 1 is a system view of one embodiment of a computing device.

FIG. 2 is a block diagram of one embodiment of a microcontroller (MCU) in the computing device of FIG. 1.

FIG. 3 is a flowchart of one embodiment of a power indicator control method.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computing device-readable medium or other storage device. Some non-limiting examples of non-transitory computing device-readable media include CDs, DVDs, BLU-RAY, flash memory, and hard disk drives.

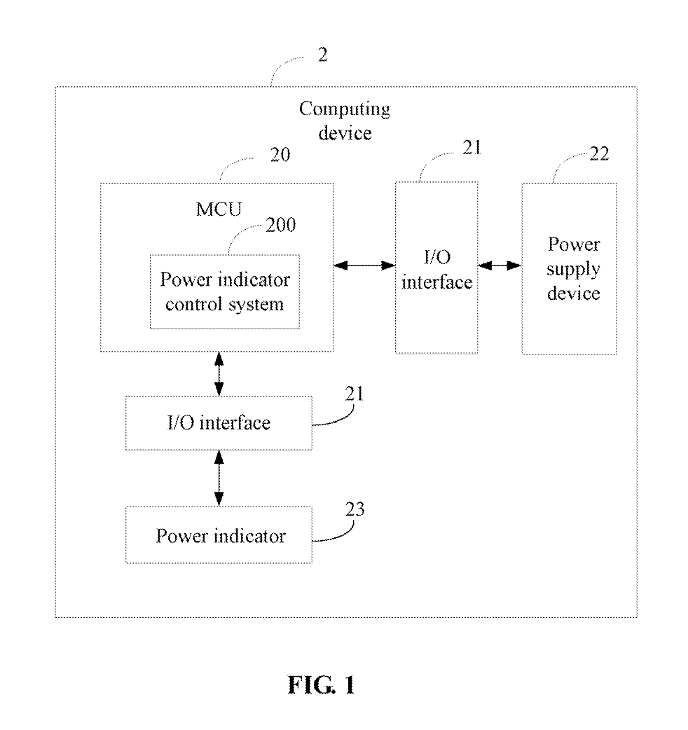

FIG. 1 is a system view of one embodiment of a computing device 2. In one embodiment, the computing device 2 may include a microcontroller (MCU) 20, one or more input output (I/O) interfaces 21, a power supply device 22, and a power indicator 23. The one or more I/O interfaces 21 are used to electronically connect the MCU 20 to the power supply device 22, and to connect the MCU 20 to the power indicator 23. In one embodiment, the I/O interfaces 21 may be, but are not limited to, a system management bus (SMBus) interface. The power supply device 22 provides power to the computing device 2. The power indicator 23 indicates different colors of light (e.g., red light, green light, blue light, yellow light, or orange light) according to a status of the power supply device 22. In one embodiment, the power indicator 23 may be, but is not limited to, a light-emitting diode (LED) device.

The MCU 20 includes a power indicator control system 200. The power indicator control system 200 is used to control the power indicator 23 to indicate the status of the power supply device 22. Further details of the power indicator control system 200 will be described below. Depending on the embodiment, the computing device 2 may be a personal computer (PC), a network server, or any other data-processing equipment.

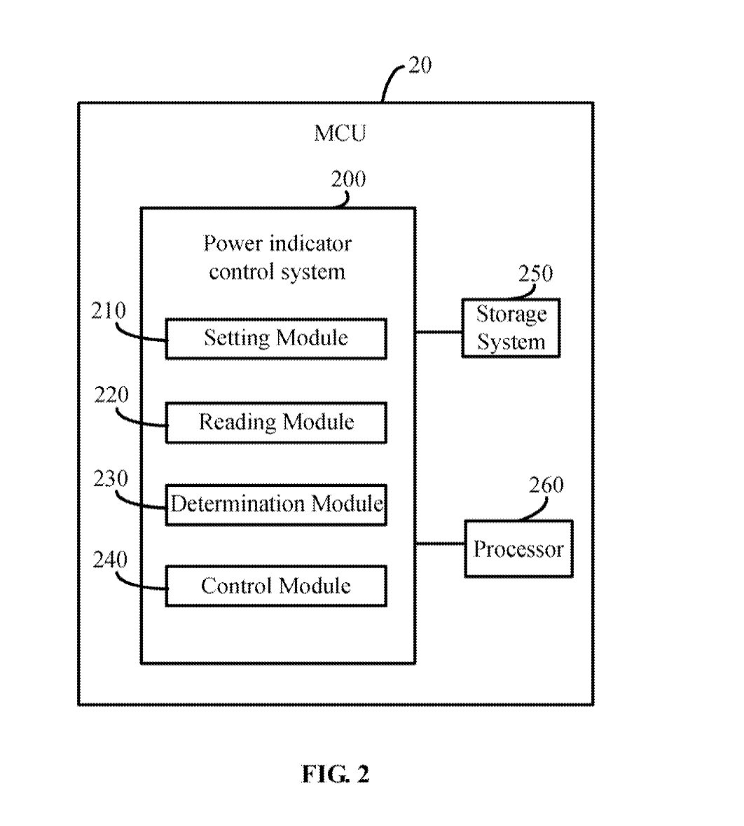

FIG. 2 is a block diagram of one embodiment of the MCU 20 in the computing device 2 of FIG. 1. In one embodiment, the MCU 20 includes a storage system 250, and at least one processor 260. The power indicator control system 200 includes a setting module 210, a reading module 220, a determination module 230, and a control module 240. The modules 210-240 may include computerized code in the form of one or more programs that are stored in the storage system 250. The computerized code includes instructions that are executed by the at least one processor 260 to provide the functions for the modules 210-240. The storage system 250 may be a cache or a memory, such as an EPROM or a flash.

The setting module 210 sets parameters for the power indicator 23. The parameters include a predetermined input voltage range, a predetermined output voltage range, and a predetermined power range, the light in a first color, the light in a second color, and the light in a third color. The light in the first color indicates that the power supply device 22 work abnormally. The light in the second color (e.g., blue light) indicates the power supply device 22 work normally. The light in the third color (e.g., green light) indicates the power supply device 22 is at a standby status. In one embodiment, the predetermined input voltage range may be 110 volt (V)-220V. The predetermined output voltage range may be 10V-12V. The predetermined power range may be 0 watt (W)-500 W. In one embodiment, the power indicator 23 indicates the red light when the power supply device 22 works abnormally. The power indicator 22 indicates the blue light when the power supply device 22 works normally. The power indicator 22 indicates the green light when the power supply device 22 is at the standby status.

The reading module 220 reads an input voltage of the power supply device 22. In one embodiment, the power supply device 22 is connected to an power network and receives the input voltage from the power network. The input voltage of the power supply device 22 is the voltage of the power network. The input voltage from the power network is an alternating current (AC) voltage.

The determination module 230 determines if the read input voltage of the power supply device 22 falls within the predetermined input voltage range. For example, the determination module 230 determines if the read input voltage of the power supply device 22 falls within 110V-220V.

The reading 210 further reads an output voltage of the power supply device 22 if the read input voltage of the power supply device 22 falls within the predetermined input voltage range. In one embodiment, the power supply device 22 converts the input voltage into the output voltage, and provides the output voltage to the computing device 2. The output voltage is a direct current (DC) voltage.

The determination module 230 determines if the read output voltage of the power supply device 22 falls within the predetermined output voltage range. For example, the determination module 230 determines if the read output voltage of the power supply device 22 falls within 10V-12V.

The reading module 210 further reads a power of the power supply device 22 if the read output voltage of the power supply device 22 falls within the predetermined output voltage range.

The determination module 230 determines if the read power of the power supply device 22 falls within the predetermined power range.

The control module 240 controls the power indicator 23 to indicate the light. In one embodiment, if the read input voltage of the power supply device 22 falls outside 110V-220V, the power supply device 22 is determined to work abnormally, and the control module 240 controls the power indicator 23 to indicate the red light. If the read input voltage of the power supply device 22 falls within 110V-220V, and the read output voltage of the power supply device 22 falls outside 10V-12V, the power supply device 22 is determined to be in the standby mode, the control module 240 controls the power indicator 23 to indicate the green light. If the read input voltage of the power supply device 22 falls within 110V-220V, the read output voltage of the power supply device 22 falls within 10V-12V, and the read power of the power supply device 22 falls within 0 W-500 W, the power supply device 22 is determined to work normally, the control module 240 controls the power indicator 23 to indicate the blue light. If the read input voltage of the power supply device 22 falls within 110V-220V, the read output voltage of the power supply device 22 falls within 10V-12V, and the read power of the power supply device 22 falls outside 0 W-500 W, the power supply device 22 is determined to work abnormally, the control module 240 controls the power indicator 23 to indicate the red light.

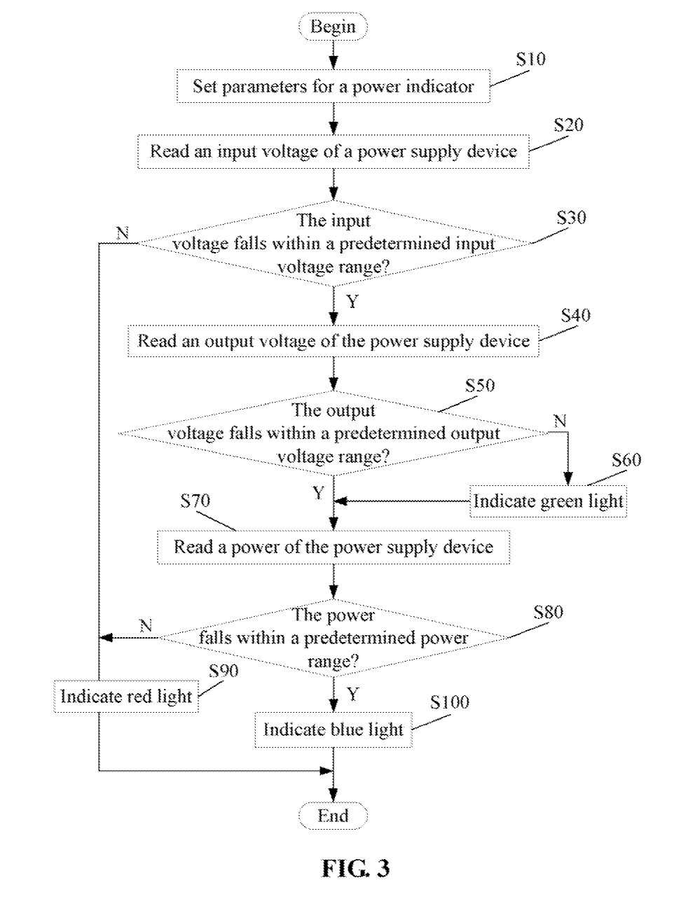

FIG. 3 is a flowchart of one embodiment of a power indicator control method. Depending on the embodiment, additional blocks may be added, others deleted, and the ordering of the blocks may be changed.

In step S10, the setting module 210 sets parameters for the power indicator 23. In one embodiment, the predetermined input voltage range may be 110V-220V. The predetermined output voltage range may be 10V-12V. The predetermined power range may be 0 W-500 W. In one embodiment, the power indicator 23 indicates the red light when the power supply device 22 works abnormally. The power indicator 22 indicates the blue light when the power supply device 22 works normally. The power indicator 22 indicates the green light when the power supply device 22 is at the standby status.

In step S20, the reading module 220 reads an input voltage of the power supply device 22. In one embodiment, the power supply device 22 is connected to an power network and receives the input voltage from the power network. The input voltage of the power supply device 22 is the input voltage of the power network. The input voltage is an alternating current (AC) voltage.

In step S30, the determination module 230 determines if the read input voltage of the power supply device 22 falls within the predetermined input voltage range. In one embodiment, if the read input voltage of the power supply device 22 falls within 110V-220V, procedure goes to step S40. Otherwise, if the read input voltage of the power supply device 22 falls outside 110V-220V, procedure goes to step S90.

In step S40, the reading 210 reads an output voltage of the power supply device 22. In one embodiment, the power supply device 22 converts the input voltage into the output voltage, and provides the output voltage to the computing device 2. The output voltage is a direct current (DC) voltage.

In step S50, the determination module 230 determines if the read output voltage of the power supply device 22 falls within the predetermined output voltage range. In one embodiment, if the read output voltage of the power supply device 22 falls within 10V-12V, procedure goes to step S70. Otherwise, if the read output voltage of the power supply device 22 falls outside 10V-12V, procedure goes to S60.

In step S60, the control module 240 controls the power indicator 23 to indicate the green light.

In step S70, the reading module 210 reads a power of the power supply device 22.

In step S80, the determination module 230 determines if the read power of the power supply device 22 falls within the predetermined power range. In one embodiment, if the read power of the power supply device 22 falls outside 0 W-500 W, procedure goes to step S90. Otherwise, if the read power of the power supply device 22 falls within 0 W-500 W, procedure goes to step S100.

In step S90, the control module 240 controls the power indicator 23 to indicate the blue light.

In step S100, the control module 240 controls the power indicator 23 to indicate the red light.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A microcontroller (MCU), the MCU in electronic communication with a power supply device and a power indicator, comprising:
a storage system;
at least one processor; and
one or more programs stored in the storage system and being executable by the at least one processor, the one or more programs comprising:
a reading module that reads an input voltage of the power supply device, reads an output voltage of the power supply device, and reads a power of the supply device;
a determination module that determines if the read input voltage of the power supply device falls within a predetermined input voltage range, determines if the read output voltage of the power supply device falls within a predetermined output voltage range, and determines if the read power of the power supply device falls within a predetermined power range; and
a control module that controls the power indictor to indicate light in a first color in response to a determination that the read input voltage of the power supply device falls outside a predetermined input voltage range, controls the power indictor to indicate light in a second color in response to the determination that the read output voltage of the power supply device falls outside a predetermined output voltage range, and controls the power indictor to indicate light in a second color in response to the determination that the read power of the power supply device falls within a predetermined power range.

2. The MCU of claim 1, wherein color of the light is selected from the group consisting of red light, green light, blue light, yellow light, and orange light.

3. The MCU of claim 2, wherein the power indicator indicates the red light when the power supply device works abnormally, and the power indicator indicates the red light upon the condition that the read input voltage of the power supply device falls outside the predetermined input voltage range.

4. The MCU of claim 2, wherein the power indicator indicates the green light when the power supply device is at a standby mode, and the power indicator indicates the green light upon the condition that the read input voltage of the power supply device falls within the predetermined input voltage range, and the read output voltage of the power supply device falls outside the predetermined output voltage range.

5. The MCU of claim 2, wherein the power indicator indicates the blue light when the power supply device work normally, and the power indicator indicates the blue light upon the condition that the read input voltage of the power supply device falls within the predetermined input voltage range, the read output voltage of the power supply device falls within the predetermined output voltage range, and the read power of the power supply device falls within the predetermined power range.

6. The MCU of claim 1, wherein the power indicator is a light-emitting diode (LED) device.

7. A power indicator control method implemented by a microcontroller (MCU), the MCU in electronic communication with a power supply device and a power indicator, the method comprising:
reading an input voltage of the power supply device, reading an output voltage of the power supply device, and reading a power of the supply device;
determining if the read input voltage of the power supply device falls within a predetermined input voltage range, determining if the read output voltage of the power supply device falls within a predetermined output voltage range, and determining if the read power of the power supply device falls within a predetermined power range; and
controlling the power indictor to indicate light in a first color in response to a determination that the read input voltage of the power supply device falls outside a predetermined input voltage range, controlling the power indictor to indicate light in a second color in response to the determination that the read output voltage of the power supply device falls outside a predetermined output voltage range, and controlling the power indictor to indicate light in a second color in response to the determination that the read power of the power supply device falls within a predetermined power range.

8. The method of claim 7, wherein color of the light is selected from the group consisting of red light, green light, blue light, yellow light, and orange light.

9. The method of claim 8, wherein the power indicator indicates the red light when the power supply device works abnormally, and the power indicator indicates the red light upon the condition that the read input voltage of the power supply device falls outside the predetermined input voltage range.

10. The method of claim 8, wherein the power indicator indicates the green light when the power supply device is at a standby mode, and the power indicator indicates the green light upon the condition that the read input voltage of the power supply device falls within the predetermined input voltage range, and the read output voltage of the power supply device falls outside the predetermined output voltage range.

11. The method of claim 8, wherein the power indicator indicates the blue light when the power supply device work normally, and the power indicator indicates the blue light upon the condition that the read input voltage of the power supply device falls within the predetermined input voltage range, the read output voltage of the power supply device falls within the predetermined output voltage range, and the read power of the power supply device falls within the predetermined power range.

12. The method of claim 7, wherein the power indicator is a light-emitting diode (LED) device.

13. A non-transitory computing device-readable medium having stored thereon instructions that, when executed by a microcontroller (MCU), the MCU in electronic communication with a power supply device and a power indicator, causing the computing device to perform a power indicator control method, the method comprising:
reading an input voltage of the power supply device, reading an output voltage of the power supply device, and reading a power of the supply device;
determining if the read input voltage of the power supply device falls within a predetermined input voltage range, determining if the read output voltage of the power supply device falls within a predetermined output voltage range, and determining if the read power of the power supply device falls within a predetermined power range; and
controlling the power indictor to indicate light in a first color in response to a determination that the read input voltage of the power supply device falls outside a predetermined input voltage range, controlling the power indictor to indicate light in a second color in response to the determination that the read output voltage of the power supply device falls outside a predetermined output voltage range, and controlling the power indictor to indicate light in a second color in response to the determination that the read power of the power supply device falls within a predetermined power range.

14. The medium of claim 13, wherein color of the light is selected from the group consisting of red light, green light, blue light, yellow light, and orange light.

15. The medium of claim 14, wherein the power indicator indicates the red light when the power supply device works abnormally, and the power indicator indicates the red light upon the condition that the read input voltage of the power supply device falls outside the predetermined input voltage range.

16. The method of claim 14, wherein the power indicator indicates the green light when the power supply device is at a standby mode, and the power indicator indicates the green light upon the condition that the read input voltage of the power supply device falls within the predetermined input voltage range, and the read output voltage of the power supply device falls outside the predetermined output voltage range.

17. The method of claim 14, wherein the power indicator indicates the blue light when the power supply device work normally, and the power indicator indicates the blue light upon the condition that the read input voltage of the power supply device falls within the predetermined input voltage range, the read output voltage of the power supply device falls within the predetermined output voltage range, and the read power of the power supply device falls within the predetermined power range.

18. The method of claim 13, wherein the power indicator is a light-emitting diode (LED) device.
